(19) United States
(12) Patent Application Publication
(10) Pub. No.: US 2012/0032782 A1
(43) Pub. Date: Feb. 9, 2012

(54) SYSTEM FOR RESTRICTED BIOMETRIC ACCESS FOR A SECURE GLOBAL ONLINE AND ELECTRONIC ENVIRONMENT

(76) Inventor: Brian A. Colella, Shady Side, MD (US)

(21) Appl. No.: 13/114,547

(22) Filed: May 24, 2011

Related U.S. Application Data
(63) Continuation-in-part of application No. 11/646,121, filed on Dec. 27, 2006, now Pat. No. 7,949,609.
Application No. 11/646,121 is a continuation-in-part of application No. 12/231,544, filed on Sep. 2, 2008, now Pat. No. 7,953,670.

(51) Int. Cl. G06F 7/04

(52) U.S. Cl. 340/5.83

(57) ABSTRACT

A method and system for biometric-secure settings that also simplifies the checkout process and eliminates fraudulent transactions. The system relies on an exchange service provider (RAGE) that hosts multiple servers: one implementing a web portal for secure online banking, auctions and other exchange opportunities, another being a biometric fingerprint device authenticating database, and yet another being a transaction traffic manager. Participating banks and supporting institutions distribute and activate Secure Individual Identity Devices (SIIDs) to registered users, each SIID being a portable biometric activated identification device that locally stores a fraction of the enrolled users fingerprint (minutia) along with an encrypted code that is used to verify and authenticate the user, eliminating the use of personal or financial information for this purpose. The SiiD becomes the user's own personal key for completing secure online transactions. The user simply plugs their SiiD into any equipped device for activation and scans their own fingerprint for each transaction. The encrypted codes are authenticated in the DSP database and the transaction is processed to the appropriate financial institutions.

### CROSS-REFERENCE TO RELATED APPLICATIONS

The present application is a continuation-in-part of U.S. application Ser. No. 11/646,121 filed 27 Dec. 2006, and a continuation-in-part of U.S. application Ser. No. 12/231,544 filed Sep. 2, 2008.

### BACKGROUND OF THE INVENTION

1. Field of the invention

The present invention relates to biometric computing access and, more particularly, to a biometric-secured-access global computing environment through the use of biometric activated devices that eliminate the need of user names, passwords, pins, tokens or other sign-on methods.

2. Description of the Background

The challenges of monitoring and controlling access to computer resources is becoming more difficult each day because unauthorized criminals, terrorists and mischievous hackers are becoming more sophisticated in their efforts to circumvent computer systems. As a result, consumers hesitate to shop online and some still refuse to use a credit card or personal information due to their perception of utter insecurity. Consequently, many credit companies are investing in technologies to help make credit purchases more secure. Some credit cards now display a photograph of the cardholder so criminals can't make face-to-face purchases with a stolen credit card. Many cards have holograms, secret imprints, or hidden images so thieves have a harder time making a new credit card with a stolen credit card number. Credit card companies are also pressuring merchants to be more wary, and retailers are trying new security measures. On the other hand, over-zealous security measures wind up costing sales too. Security usually increases the transaction time, and consumers do not like spending excessive time while more secure transactions re cleared. They also do not like registering their personal information in too many places due to identity theft. Consumers like a balance between security and convenience.

Biometric authentication is gaining popularity as a security measure, and especially fingerprints. For example, U.S. Pat. No. 6,950,810 to Lapsley et al. (Indivos Corporation) issued Sep. 27, 2005 shows a token less biometric electronic financial transactions method for authorization of an electronic payment between a payor and a payee using a third party provider. Users register with the third party and give a fingerprint, as well as their financial account information. During an online auction the bidder provides their fingerprint.

United States Patent Application 20040199469 by Barillova et al. published Oct. 7, 2004 shows a method and system for authentication of online commercial transactions between a customer and a merchant comprising the steps of registering a customer with a PIN and a biometric sample, and a customer financial account.

United States Patent Application 20050165700 by Karthik (Multimedia Glory) published Jul. 28, 2005 shows a security system for electronic commerce for verifying the authenticity of a user including a server authentication program installed in a web-server, a client software component and fingerprint scanner installed at a workstation of the user. The scanner takes and converts a biometrics image into digital data, which is then compressed and encrypted, and transmitted to the web-server.

U.S. Pat. No. 6,944,773 to Abrahams issued Sep. 13, 2005 shows a method of on-line authentication in which a user presents one or more fingerprints for authentication during an on-line transaction, such as an Internet transaction. The host system indicates how many fingerprints will be requested for authentication, randomly selects which fingerprints will be requested, and sends a request for entry of the randomly selected fingerprints, and then compares the received fingerprint data to fingerprint data stored in a database.

U.S. Pat. No. 6,241,288 issued to Bergenek et al. in 2001 shows a fingerprint identification/verification algorithm that uses bitmaps of a stored fingerprint to correlate with a bit map of an input fingerprint, wherein an accurate reference point is located. This is followed by the selection of several two-dimensional areas in the vicinity of the reference point of the input image of the fingerprint. These areas are then correlated with stored fingerprint recognition information to determine if the input fingerprint image and the stored fingerprint recognition information are sufficiently similar to identify/verify the input fingerprint.

U.S. Pat. No. 4,229,023 to Luz issued Oct. 21, 1980 shows an identity check card with a fingerprint cut away in spots to provide alternate transparent zones and partial fingerprint zones. The placement of the card over a fresh fingerprint show immediately if the latter complements the former, thus permitting a quick and reliable check to be effected.

U.S. Pat. No. 5,869,822 to Meadows et al. issued Feb. 9, 1999 shows an automated fingerprint identification system. When a person applies for a credit card they must register a finger of their choice with the card issuance company. At the company, the finger is scanned and a composite number is produced that consists of several fingerprint-identifying parameters. The composite number is encoded onto the card and is stored in a card database. When a person wants to use the card, the card is inserted into a card reader and the person's finger is scanned by a fingerprint scanner, which produces a composite number. The immediate and stored composite numbers are compared and, when similar, use of the card is allowed.

Internet Commerce Account Status Information (ICASI) sells a third party service that requires a biometric finger-scan to authorize use of a business bank account, credit card transaction, or online commerce. Once users have registered their fingerprints, they can conduct business with thousands of participating merchants. A window pops up asking users for authentication via the finger scanner. The scanner plugs into a USB port. The finger-scanner creates a “template” that is used to authenticate. A template can never be converted back to the original fingerprint. All fingerprint information is gathered using SSL encryption, then stored securely on computers not accessible from the outside. ICASI strives for privacy and will not sell or share information with any other company.

The TouchPass log-on security solution by NEC Technologies, Inc. offers finger-imaging technology to authenticate an individual's identity.

Digital Persona, Inc. provides a complete fingerprint security system for PCs using USB fingerprint sensors. The plug-and-play USB fingerprint sensor is self-calibrating, and features auto and optimal image capture, latent image removal, a challenge-response link, and encrypted transmission of biometric information.

While the foregoing references all teach improved security through fingerprint biometrics, none suggests a secure single sign-on solution using biometrics to accurately identify individual users, and authorize their access to computers, networks and applications using only a fingerprint. What is needed is a system for performing the following steps:

1. user authentication;
2. device authentication;
3. authentication verified;
4. secure encrypted access is granted;

All using a biometric device insertable into any internet accessible USB port. A user swipes their finger on the biometric device, then in milliseconds access is granted to any pre-approved designated venue. This creates an environment where users can securely access and use restricted sites and are protected in their actions while signing-on, navigating and using secure sites and the content they are authorized to access. The system provides safe and secure access for those who require a secure environment to conduct any form of commerce, data capture or secure intelligence, free from hackers, spam and unauthorized users.

### SUMMARY OF THE INVENTION

Accordingly, it is an object of the present invention to assist merchants, consumers, businesses and governments in protecting themselves against the dramatic increase in unauthorized access of private and critical information via biometric security, while also ensuring complete privacy of user's personal and financial data either physically or logically.

It is another object to provide a convenient method for biometric-secure single-sign-on to VPN's, intranets or other venues that imposes the following secure multi-factor sign-on method

1. user authentication;
2. device authentication;
3. authentication verified;
4. secure encrypted access is granted;

all accomplished with a biometric device insertable into any internet accessible USB port.

It is another object to provide a low cost license fee providing a business model to facilitate biometric secure multi-factor sign-on.

It is another object to provide a convenient method to tag a device to an individual user for validation of user along with location and time of use through biometric-secure sign-in of physical or logical environments.

It is another object to provide an action filter to the system to provide a tracking method of an individual's use of biometric-secure sign-on occurrences, times and activities.

It is another object to provide a convenient method for restricting an individual user access to an approved destination(s) through a biometric-secure sign-on device that can be coded with specific device allocation credentials.

According to the present invention, the above-described and other objects are accomplished by providing a restricted access global environment (RAGE) network and to facilitate the secure multi-factor sign-on and, more particularly, a system for biometric-secure access eliminating fraudulent unauthorized use.

The RAGE serves as a host authentication agent, authenticating each user-initiated secure multi-factor sign-on access to supported institutions or authorized portals. The RAGE also provides users with a web portal for secure online banking and other exchange opportunities in the financial world. All users are required to preregister and this may be accomplished at participating banks, financial and other supporting institutions and governments with user-accessible locations.

A third party, device service provider (DSP) distributes Secure Individual Identity Devices (SIIDs) having integrated fingerprint scanners pre-programmed and registered to the participating banks, other supporting companies, institutions or governments. These institutions will be acting as a registration agent for the DSP. After distribution of such SIIDs to registration agent, these agents will manage an activation procedure whereupon each authorized user provides their bibliographic and biological information and corresponding access data to link a SIID to that user. At activation, each user completes an initial fingerprint scan on their personal SIID. In order to register, each user must visit a DSP to obtain a fingerprint scanner SIID, then registers and activate their device at the DSP. At registration, the enrollment activation scan(s) are digitized and encrypted and a portion of the digital activation scan (comprising the fingerprint minutia) is memorized by the SIID device for instant comparison at later use. The same fingerprint minutia portion of the scan is also encrypted into a passcode which is appended with a time-stamp, and the entire time-stamped passcode is stored on the SIID. The encryption sub-divides the fingerprint minutia portion into sub-portions, and cyphers each sub-portion into an encrypted alphanumeric code. The codes for each sub-portion are merged into one divisible passcode, and the timestamp is added. The SIID thus becomes the user's personal key for authenticating their online actions. At activation a divisible portion of the passcode (a “passkey” comprising, for example, one code for one minutia sub-portion sans the timestamp) is transmitted by secure (encrypted) transmission to a biometric device registrar (a separate database server hosted by the RAGE), where it is stored in a remote database for authenticating later actions. In addition, the passkey and the data direction of that user's device are sent from the registering institution to a traffic controller (also a separate server hosted by the RAGE) which serves as an action routing interface, routing each subsequent action to the supported institution hosting the designated account to be used for that action. Neither the traffic controller, nor the device registrar, nor the RAGE as a whole possesses any account, personal or sign-on information or any biometric information thereby preserving security and helping to ensure that the designated accounts cannot be compromised or breached. In effect, the RAGE only has the device passkey (an encrypted passcode) and action routing data.

The RAGE system is networked through traffic controllers and routing load balancers (via an encrypted network link) to supported institutions including; financial institutions, businesses, the medical and insurance industries, governments and educational institutions providing secure use eliminating fraudulent access. Upon consummating an online or network access action (after registration and enrollment activation), the user simply plugs their SIID into any USB port or supported card reader, and scans their own fingerprint. To proceed, the fingerprint data that the device obtains must correspond with the same data segment of the fingerprint data taken at enrollment activation. Thus, the SIID device compares the stored portion of the digital activation/enrollment scan with the corresponding portion of the instant fingerprint data. Given a match (authentication) the SIID device compiles the minutia from the live scan into the same passkey which is then transmitted through the RAGE provider to the device registrar where it is challenged by comparison to the enrollment activation passkey authenticated, and if all keys and challenges match authentication is granted. Given authentication, the user information and encrypted routing data for the action is transmitted to the traffic controller which handles routing of the action to the appropriate supporting institution. All data transmission is fully encrypted, challenged and pass-through is granted. This entire methodology is based on secure and verified user biometric authenticated access and sign-on actions eliminating fraudulent or unauthorized use. The process of securing accounts, data, private or personal information and authorized access is the method taught by this invention. It is also taught that wherever a user has to access or requires an action to access is protected thru biometric authentication eliminating any unauthorized access by spammers or hackers to an individual account or portal. Business, institutions, government agencies or private user will receive the security of verified authenticated access to any secure venue eliminating user name, passwords or pins. Since a user's own device gives instant authentication, and since only the encrypted passkey is ever transmitted (not fingerprint data or passcode), the system described herein more fully protects the user's privacy and information.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

Other objects, features, and advantages of the present invention will become more apparent from the following detailed description of the preferred embodiment and certain modifications thereof when taken together with the accompanying drawings in which:

FIG. 1 is a block diagram illustrating a preferred system architecture for biometric-secure access in accordance with the present invention.

FIG. 2 is a block diagram illustrating a preferred embodiment of the method according to the present invention.

FIG. 3 is a drawing of the fingerprint scanning SIID 90 according to a preferred embodiment of the present invention.

### DETAILED DESCRIPTION OF THE PREFERRED EMBODIMENTS

The present invention is a system, inclusive of a restricted accessed global environment (RAGE) topology and method for verifying personal ID and facilitating secure actions using encrypted biometric information. The system employs a Secure Individual Identity Device (SIID) having an integrated biometric (fingerprint) scanner for enhanced authentication and security for any logical or physical action (purchase, verify identity, banking, educational access, etc.) in online, cloud or network sign-on.

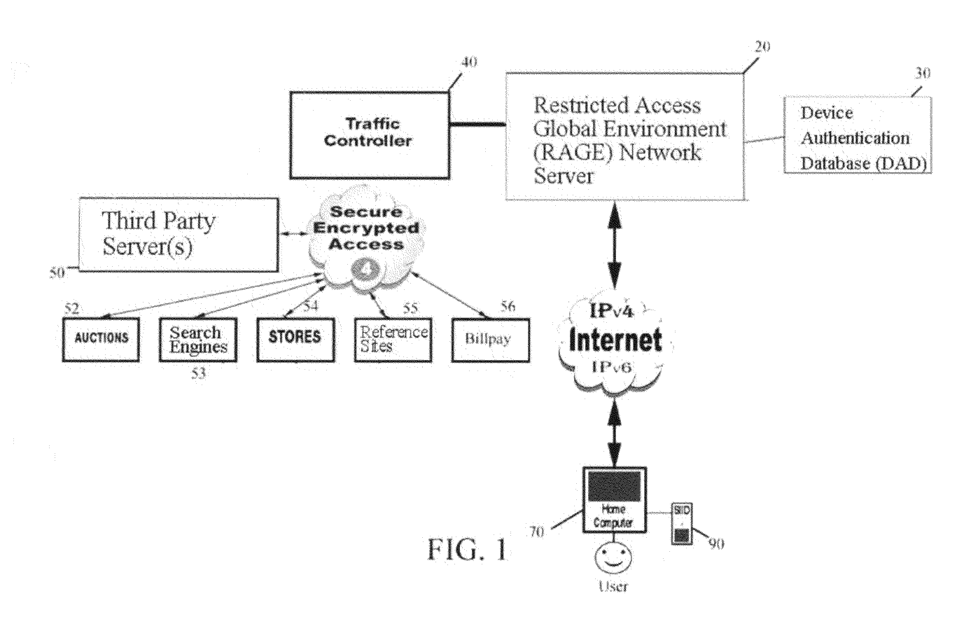

FIG. 1 is a block diagram illustrating a preferred system architecture for biometric-secure access in accordance with the present invention. The system is maintained by a device service provider (DSP) which hosts a plurality (at least three) separate servers, one server being a restricted accessed global environment (RAGE) server 20, traffic controller 40, and device authentication database (DAD) 30. Any registered users having a computer 70 or any other capable device with a USB port may access the system through the RAGE server 20 by insertion of their SIID 90 into the USB port and completion of a fingerprint scan using an integrated biometric (fingerprint) scanner on SIID 90. The RAGE server 20 is networked to the DAD 30 through a secure encrypted and dedicated communication link. The RAGE server 20 is also networked through one or more traffic controller(s) 40 and/or routing load balancers (via an encrypted network link) to the internet and selectively on to any number of supported third party institution servers 50 which may include financial institutions, businesses, the medical and insurance industries, governments and educational institutions. The RAGE server 20 is also networked through traffic controller(s) 40 selectively to any number of supported third party websites 52-56 which may include auctions 52, search engines 53, online stores 54, reference sites 55, or financial institutions/online payment sites 56. The foregoing architecture employs an authentication protocol (to be described) that ensures instant, secure and controlled access to the third party servers 50 and/or websites 52-56 via a safe and secure log-in without input of any user names, passwords, PINs or personal information (no personal data can be compromised), and eliminates fraudulent access.

All users are required to preregister and this may be accomplished at participating banks, financial and other supporting institutions and governments with user-accessible locations, or any other third party, device service provider (DSP).

The DSP distributes SIIDs 90 each having integrated fingerprint scanners pre-programmed and registered to the participating banks, other supporting companies, institutions or governments. Such institutions effectively act as a registration agent for the DSP. After distribution of such SIIDs to registration agents, these agents will manage an activation procedure whereupon each authorized user provides their bibliographic and biological information and corresponding access data to link each SIID 90 to a particular user. At activation, each user completes an initial fingerprint scan on their personal SIID 90. In order to register, each user must visit a DSP agent to obtain a fingerprint scanner SIID 90, then register and activate their device at the DSP agent facility. At registration, the enrollment activation scan(s) are digitized and encrypted and a portion of the digital activation scan (comprising the fingerprint minutia) is memorized by the SIID device 90 for instant comparison during later use. The same fingerprint minutia portion of the scan is also encrypted into a passcode which is appended with a time-stamp, and the entire time-stamped passcode is stored on the SIID 90. The encryption sub-divides the fingerprint minutia portion into sub-portions, and cyphers each sub-portion into an encrypted alphanumeric code. The alphanumeric codes for each sub-portion are merged into one divisible passcode, and the timestamp is added. At activation a divisible portion of the passcode (a “passkey” comprising, for example, one code corresponding to one minutia (sub-portion sans the timestamp) is transmitted to the DAD 30 through a secure encrypted and dedicated communication link along with the user's bibliographic and biological information and corresponding access data, where it is stored for later user authentication. The DAD 30 is a separate database server hosted by the DSP. It is noteworthy that neither the traffic controller 40, nor the device registrar, nor the RAGE server 20 as a whole possesses any account, personal or sign-on information or any biometric information thereby preserving security and helping to ensure that the designated accounts cannot be compromised or breached.

The RAGE server 20 is networked through traffic controller(s) 40 and/or routing load balancers (via an encrypted network link) to supported institutions including any number of supported third party servers 50 or supported third party websites 52-56. To gain online or network access to any such institution 50-56 (after registration and enrollment activation), the user simply plugs their SIID 90 into any USB port on computer 70 (or other web-enabled device) and scans their own fingerprint. The SIID 90 device activates (effectively turns “on”) only when the fingerprint data that the device 90 obtains correspond to the fingerprint minutia of the fingerprint data taken at enrollment activation. Thus, the SIID device 90 compares the stored portion of the digital activation/enrollment scan with the corresponding portion of the instant fingerprint data. Given a match (authentication) the SIID device 90 compiles the minutia from the live scan into the same passkey which is then transmitted through the RAGE server 20 where it is challenged by comparison to the enrollment activation passkey stored at DAD 30, and if all keys and challenges match authentication is granted.

Given authentication, the user information and encrypted routing data for the action is transmitted from DAD 30 to the RAGE server 20 and on to the traffic controller 40 which handles routing of the action to the appropriate supporting institution 50-56. All data transmission is fully encrypted, challenged and pass-through is granted. This entire methodology is based on secure and verified user biometric authenticated access and sign-on actions eliminating fraudulent or unauthorized use. The invention fully secures all accounts, data, private or personal information, and allows only authorized access to selected institutions 50-56. Since a user's own SIID device 90 gives instant authentication, and since only the encrypted passkey is ever transmitted (not fingerprint data or passcode), the system described herein more fully protects the user's privacy and information and eliminates any unauthorized access by spammers or hackers to individual accounts or unauthorized portals. Businesses, institutions, government agencies and private users benefit from the security of verified authenticated access to any secure venue without user names, passwords or PINs.

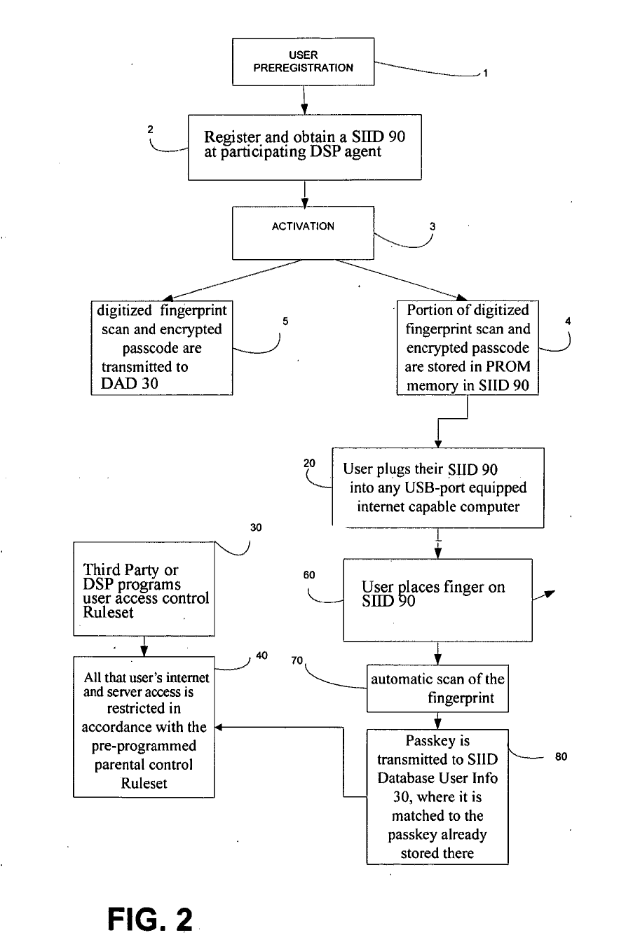

FIG. 2 is a top level flow diagram illustrating the method steps of the present invention, which will now be described in detail.

At step 1 (FIG. 2) users must first register themselves with the DSP through participating and supported DSP agents at the DSP agent facilities. This is accomplished physically at any participating DSP agent facility which essentially serves as a registration agent for the DSP service. At registration, each user obtains a SIID device 90 (at step 2), and provides their bibliographic information as well as (optionally) designated financial accounts to be used for transactions, including routing numbers.

The SIID 90 is useless until activated, and so at step 3 the user activates their SIID 90. Activation entails completing an “activation scan” of the user's fingerprints. At the activation scan the fingerprints are scanned in three-dimensions and are digitized into minutia. The minutia are derived from the ridges and furrows of the skin in 3D, and are typically located where ridge endings or bifurcations are found. There are various existing open source algorithms for accomplishing this. The SIID 90 then by sub-divides the fingerprint minutia into sub-portions and at step 4 a portion of the 3D digitized fingerprint scan (a subset of the entire minutae) is stored locally on the SIID 90 for later comparison. The stored portion of the digitized fingerprint activation scan comprises just a subset of minutia derived from the scan. Approximately 30 points of minutia are preferred as this results in a small PROM memory requirement of a minimum of 64 Kbytes. The SIID 90 then encrypts the entire minutae and cyphers each sub-portions into an encrypted alphanumeric code. The alphanumeric codes for each sub-portion are merged into one divisible passcode, and a timestamp is added.

At step 5 a divisible portion of the passcode (a “passkey” comprising, for example, one code corresponding to one minutia (sub-portion sans the timestamp) is transmitted to the DAD 30 through a secure encrypted and dedicated communication link along with the user's bibliographic and biological information and optional financial accounts/routing numbers, where it is stored for later user authentication. The user is now ready to gain authenticated access.

At step 30, third parties (as well as the DSP) may control a given user's access to their third party servers 50 (FIG. 1) by accessing the RAGE server 20 via a dedicated URL, and prescribing specific user rights, e.g., an access control Ruleset for a given user. This is important in the employer/employee context where certain employees may have greater access to employer resources than others. Once a Ruleset has been defined and attached to a specific user account at DAD 30, all of that user's interne and third party server access will be restricted in accordance with the pre-programmed access control Ruleset.

Once registered and activated, the user is free to partake in online access to websites 52-56 or access to third party servers 50, including point-of-sale transactions such as at online auctions 52 or stores 54, or online banking and bill payment facilities 56.

One skilled in the art will understand that the present method may be incorporated in any distributed architecture, over any type of communication backbone.

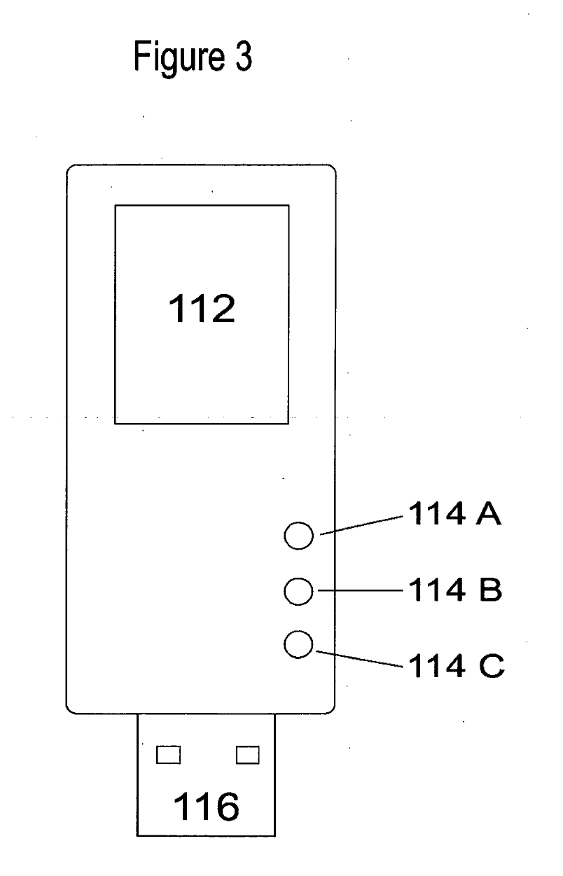

FIG. 3 illustrates the USB dongle fingerprint SIID 90 according to the present invention. SIID 90 generally comprises a small plastic housing exposing the topside of a capacitive array sensor chip to form a fingerprint scanning bed 112, and three front-mounted LED indicators 114 for indicating “power on”, and for indicating each fingerprint scan result “match” or “no match”, respectively. SIID 90 encloses a processor for controlling the scanning operation and an amount of PROM memory for storing the activation information. Preferably 128 kB of PROM are used, the fingerprint accounting for about half this space. SIID 90 also includes a standard USB port connector 116 protruding from one end for insertion into any computer. Again, this SIID 90 becomes the user's personal key for authenticating each and every online or supporting portal transaction. Upon consummating an online transaction, the user simply plugs the USB port connector 116 into any computers or other supported USB device, and scans their own fingerprint. SIID 90 is programmed to process only a portion of the scan area and convert that scan data to a corresponding code based on distinguishing fingerprint characteristics lying within the apportioned scan area. The SIID 90 does not require the use of any external sensors, algorithms, template matches or database access. The capacitive array sensor chip is preferably a third generation capacitive array sensor chip that detects and captures small variations in the finger surface capacitance and creates a three-dimensional electrical image of the fingerprint's unique pattern. The SIID 90 detects placement of finger thereon, automatically scans, and at activation the unique features of the image are extracted to form its own encrypted template, which is then stored into protected memory in the SIID 90. Upon completion of the enrollment process, the SIID 90 becomes “locked” and subsequent placement of any enrolled finger on the sensor triggers the verification process. This involves comparing the previously stored “registered” template with the current finger, and authentication by a successful comparison of the subsets of “minutiae” from the live scan to those stored locally. The SIID 90 can also be programmed to permit an emergency response feature in the case of an unauthorized or unwanted attempt at use.

It should now be apparent that the above-described system provides a secure single sign-on solution using biometrics to for performing the following steps:

1. user authentication;
2. device authentication;
3. authentication verified;
4. secure encrypted access is granted.

The method and system accurately identifies individual users, and authorizes their access to computers, networks and applications using a biometric device insertable into any interne accessible USB port. A user swipes their finger on the biometric device, then in milliseconds access is granted to any pre-approved designated venue. This creates an environment where users can securely access and use restricted sites and are protected in their actions while signing-on, navigating and using secure sites and the content they are authorized to access. The system provides safe and secure access for those who require a secure environment to conduct any form of commerce, data capture or secure intelligence, free from hackers, spam and unauthorized users.

Having now fully set forth the preferred embodiments and certain modification of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. For authentication and enhanced security during online computer use, a method comprising the steps of:
registering each of a plurality of users at one of a plurality of institutions by the following subset's,
distributing a Secure Individual Identity Device to each of a plurality of users, each said Secure Individual Identity Device comprising a portable biometric (fingerprint) scanner having internal memory and a USB plug,
receiving bibliographic information and designated financial account information from each user to be used for user transactions,
activating each Secure Individual Identity Device by initially scanning the fingerprints of the assigned user, digitizing said fingerprint minutia scan, and storing (minutia data), a portion of the digitized fingerprint scan locally in the memory of said Secure Individual Identity Device for later comparison,
encrypting by said Secure Individual Identity Device the same portion of the digitized fingerprint minutia scan into an encrypted alphanumeric passcode, and storing said passcode locally in the memory of said Secure Individual Identity Device along with a time stamp and said fingerprint minutia,
transmitting by said Secure Individual Identity Device a encrypted passkey code to a remote SIID biometric registrar database, said passkey comprising a portion of said encrypted alphanumeric passcode,
transmitting by said Secure Individual Identity Device said passkey code to a remote traffic controller database cross-referencing each user passkey to their designated account routing data for each designated account; and, after said registering step;
one of said registered users consummating an electronic transaction by the following substeps,
plugging their Secure Individual Identity Device into any computer USB port or supported card reader,
receiving said registered user's finger on said Secure Individual Identity Device and automatically receiving a scan of the registered user's fingerprint, digitizing by said Secure Individual Identity Device a portion of the scanned fingerprint minutia and translating said image into a time-stamped encrypted passcode for authentication and verification of said registered user when compared to the encrypted alphanumeric passcode transmitted to said remote SIID biometric registrar database.
